(19) United States
(12) Patent Application Publication
(10) Pub. No.: US 2008/0307914 A1
(43) Pub. Date: Dec. 18, 2008

(54) Drive mechanism for a motorized vehicle

(76) Inventor: Nicholas A. Trapp, Woodruff, WI (US)

Correspondence Address: WILHELM LAW SERVICE, S.C., 100 W LAWRENCE ST, THIRD FLOOR, APPLETON, WI, 54911, US

(21) Appl. No.: 12/157,504

(22) Filed: Jun. 10, 2008

Related U.S. Application Data
(60) Provisional application No. 60/934,436, filed on Jun. 13, 2007.

(51) Int. Cl. F16H 1/12

(52) U.S. Cl. 74/416

(57) ABSTRACT

A drive mechanism for a motorized vehicle is disclosed which is reliable and requires less maintenance. The drive mechanism includes a differential having at least one rotatable shaft extending outward therefrom and having a first gear mounted thereon. A drive shaft having a first end and a second end with a gear mounted to each of the first and second ends rotatably meshes with the first gear on the rotatable shaft. The first gear also provides a pivot point for the drive shaft. The drive mechanism further includes a hub capable of supporting a rotatable member. The hub has a second gear mounted thereto which rotatably meshes with the gear mounted to the second end of the drive shaft. Lastly, the drive mechanism includes a hollow support arm extending between the pivot point and the hub. The hollow support arm has a vertical vector and completely encloses the drive shaft.

### CROSS-REFERENCE TO RELATED APPLICATION

This patent application is a regular patent application claiming priority to U.S. provisional patent application 60/934,436, filed Jun. 13, 2007.

### FIELD OF THE INVENTION

This invention relates to a drive mechanism for a motorized vehicle. More specifically, this invention relates to a drive mechanism for an all terrain vehicle (ATV) utilizing a drive shaft enclosed within a housing having a vertical vector.

### BACKGROUND

In recent years, there has been a big surge, especially in the United States, in the development and sale of three and four wheel vehicles. Such vehicles can be used for recreation or for work and can be used both indoors and outdoors. An all terrain vehicle, also known as an ATV, represent one category of recreational vehicles. The ATV's are designed and built to carry one or two people along with recreational equipment. People use such ATV's for riding trails through the woods, driving across open terrain, such as fields and meadows, and for carrying themselves and equipment into remote areas in order to camp, hunt or enjoy nature. Most ATV's manufactured today have a pair of front wheels and a pair of rear wheels. This four wheel design has evolved from a three wheel design having a single front wheel and a pair of rear wheels. In either arrangement, each of the pair of rear wheels is spaced apart from the other rear wheel by more than about 2 feet and each is aligned parallel to the other wheel. The four wheel designs are more stable than the three wheel design. However, both types of ATV's are marketed as being built for outdoor use and are capable of being driven over rough, semi-rough or smooth terrain, through shallow creek beds, over rocky hill sides or over various contoured landscapes. ATV's can also be ridden on paved or dirt roads. ATV's can be considered the fair weather cousin of snow mobiles and are normally ridden in the spring, summer and fall seasons. However, some people ride them year round.

It should be understood that ATV's can also be ridden indoors on prearranged race tracks or obstacle courses.

Most ATV's are built with independent suspensions utilizing two or more constant velocity joints, each covered by a protective boot. The protective boot is designed to prevent dirt, rocks, stones, twigs, water, mud, moisture, snow, ice, slush and other debris or condensation from contacting the constant velocity joint and ruining it. Protective boots, commonly constructed of rubber, have been used for many years on a wide variety of vehicles. Most vehicles, such as automobiles and trucks, which use constant velocity joints, are primarily driven on paved roads.

It has been recognized that ATV's commonly encounter harsher conditions then a regular automobile. Once a protective boot is compromised by a tear, a perforation, a crack, or becomes torn by contacting a sharp rock or stick, it quickly becomes unfit for its intended purpose. Once a protective boot is cut, perforated or torn open, it will eventually fail to perform its intended function of protecting the constant velocity joint from becoming contaminated. This could lead to premature failure of the constant velocity joint. The cost to repair a constant velocity joint is expensive and it takes a mechanic time to perform the task.

This potential problem can be avoided by using a newly designed drive mechanism which encloses a drive shaft within a protective housing having a vertical vector.

### SUMMARY OF THE INVENTION

Briefly, this invention relates to a drive mechanism for a motorized vehicle which is more reliable and requires less maintenance. The drive mechanism includes a powered drive having at least one rotatable shaft extending outward therefrom and having a first gear mounted thereon. A drive shaft having a first end and a second end with a gear mounted to each of the first and second ends rotatably meshes with the first gear on the rotatable shaft. This rotatable joint also provides a pivot point for the drive shaft. The drive mechanism further includes a rotatable hub capable of supporting a movable member. The hub has a second gear mounted thereto which rotatably meshes with the gear mounted to the second end of the drive shaft. Lastly, the drive mechanism includes a support arm extending between the pivot point and the hub. The support arm has a vertical vector and has sufficient length to completely enclose the drive shaft.

In another embodiment, a drive mechanism for a motorized vehicle includes a differential having a pair of coaxially aligned shafts extending outward from the differential in opposite directions. Each of the shafts is capable of rotating in a given direction and at a predetermined speed. A first gear is mounted to an end of each of the pair of coaxially aligned shafts. A pair of drive shafts, each having a first end and a second end with a gear mounted to each of the first and second ends, rotatably meshes with one of the first gears. This rotatable joint also provides a pivot point for each of the drive shafts. The drive mechanism further includes a pair of hubs each capable of supporting a movable member. Each of the hubs has a second gear mounted thereto which rotatably meshes with one of the gears mounted to the second end of the pair of drive shafts. Lastly, the drive mechanism includes a pair of support arms each extending between one of the pair of pivot points and one of the pair of hubs. Each of the pair of support arms has a vertical vector and each of the pair of support arms completely encloses one of the pair of drive shafts.

The general object of this invention is to provide a drive mechanism for a motorized vehicle designed for indoor or outdoor use and which is free of constant velocity joints covered by protective boots. A more specific objective of this invention is to provide a drive mechanism for an all terrain vehicle (ATV) which completely encloses a drive shaft within a protective support arm and wherein the support arm has a vertical vector.

Another object of this invention is to provide a drive mechanism for a motorized vehicle which is more reliable, less susceptible to breaking down and requires less maintenance.

A further object of this invention is to provide a drive mechanism and a suspension mechanism for an all terrain vehicle (ATV) which is easy to manufacture and assemble.

Still another object of this invention is to provide a drive mechanism for a vehicle designed for indoor or outdoor use which is more dependable and can carry a longer warranty.

Still further, an object of this invention is to provide a drive mechanism for a motorized vehicle which has greater ground clearance than conventional, horizontal solid axle drive mechanisms.

Other objects and advantageous of the present invention will become more apparent to those skilled in the art in view of the following description and the accompanying drawings.

### BRIEF DESCRIPTION OF THE DRAWINGS

FIG. 1 is a side view of a motorized vehicle, such as an all terrain vehicle (ATV), having a pair of front wheels and a pair of rear wheels attached to a frame which supports a seat and a pair of handle bars.

FIG. 2 is a top view of a drive train used in the motorized vehicle depicted in FIG. 1 showing a pair of hollow support arms extending downward and rearward from a rear differential.

FIG. 3 is a partially cut away view of the motorized vehicle shown in FIG. 1 depicting the arrangement of the drive train.

FIG. 4 is a cross-sectional view taken along line 4-4 of FIG. 2 showing of a drive mechanism utilizing a pair of downwardly and rearwardly extending hollow support arms, each having a vertical vector, to protect a pair of drive shafts.

FIG. 5 is a side elevation view of the right rear wheel showing the orientation of one of the hollow support arms along with a suspension mechanism.

### DETAILED DESCRIPTION OF THE INVENTION

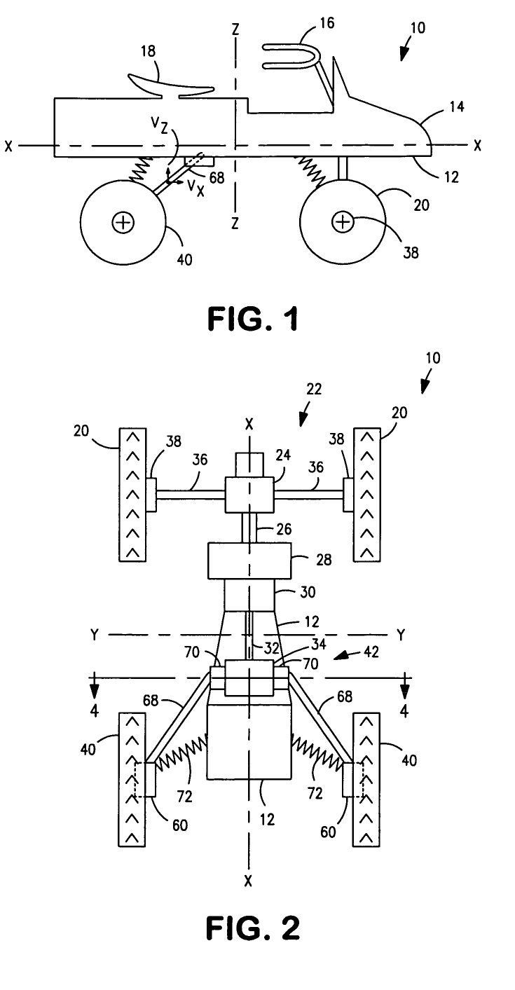

Referring to FIGS. 1 and 2, a motorized vehicle 10 is shown having a longitudinal axis X-X, a transverse axis Y-Y, see FIG. 2, and a vertical axis Z-Z. The motorized vehicle 10 can be an all terrain vehicle, commonly referred to as an ATV. The motorized vehicle 10 has a frame 12 which supports a body 14. The motorized vehicle 10 can vary in size, appearance and function. The motorized vehicle 10 can be designed and built to be used indoor and/or outdoors for recreational and/or work purposes. The motorized vehicle 10 can be ridden on paved roads, on dirt roads, on dirt trails or over natural terrain. It is common for the motorized vehicle 10 to be driven through the woods or be driven across open fields and meadows where no trails are present. Many states have federal, state and county lands, such as parks, open to motorized vehicles. In addition, many individuals own recreational land or have access to farm land on which the motorized vehicle 10 can be ridden.

The motorized vehicle 10 can be an all terrain vehicle (ATV) having three or four wheels. The motorized vehicle 10 can also be a golf cart, a three wheel motorcycle, a jeep, a utility vehicle, a fork lift, etc. designed for use on a farm or by various businesses. Desirably, the motorized vehicle 10 is a recreational vehicle, such as an all terrain vehicle (ATV). The motorized vehicle 10 can have one, two, three or four wheel drive. Desirably, it has either two or four wheel drive. When the motorized vehicle 10 is a two wheel drive vehicle, the rear two wheels are the drive wheels. The motorized vehicle 10 is primarily designed to carry one or two people and equipment over rough, semi-rough or smooth terrain.

Still referring to FIG. 1, the motorized vehicle 10 includes a steering mechanism 16, depicted as a pair of handle bars. However, it should be understood that the steering mechanism 16 can be a standard steering wheel, a joy stick or any other steering mechanism known to those skilled in the art. A driver seat 18 is also secured to the frame 12 and/or to the body 14 of the motorized vehicle 10. The driver seat 18 supports a driver of the motorized vehicle 10 and is normally located rearward of the steering mechanism 16. The driver seat 18 can be mounted to the body 14 by a suspension system (not shown) to provide a comfortable ride. A second seat, not shown, can also be utilized to support a passenger on the motorized vehicle 10. The second seat can be located behind or to the one side of the driver seat 18.

The steering mechanism 16 is located forward of the driver seat 18 and provides a means for the driver to steer a pair of front wheels 20. It should be understood that a single front wheel 20 can be substituted for the pair of front wheels 20. When a single front wheel 20 is present, it is customarily aligned with the longitudinal axis X-X of the motorized vehicle 10.

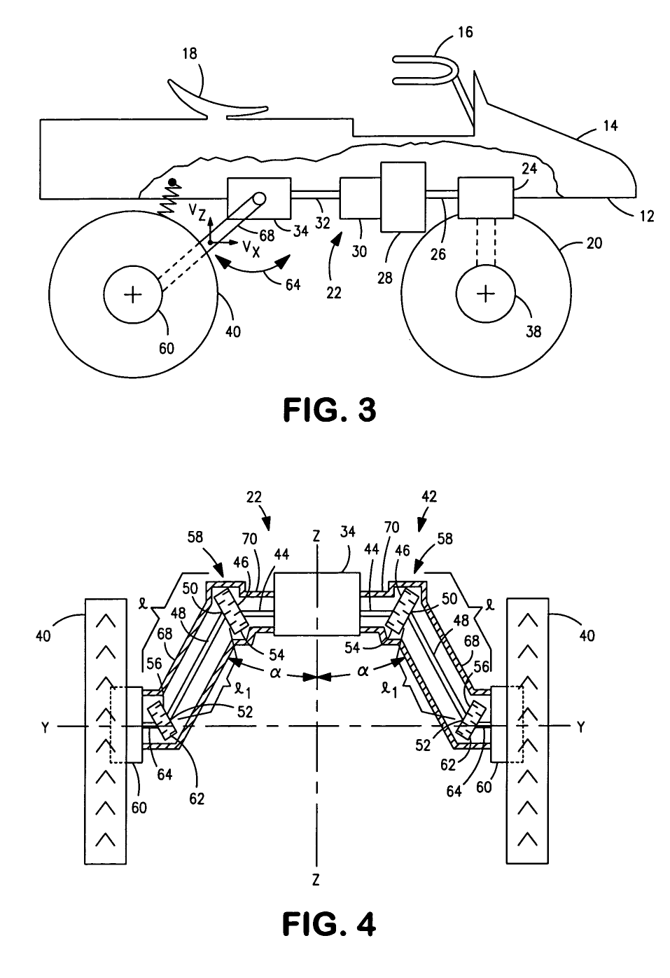

Referring now to FIGS. 2 and 3, one example of a drive train 22 is shown. The drive train 22 is aligned parallel to a longitudinal axis X-X of the motorized vehicle 10 and perpendicular to a transverse axis Y-Y. The drive train 22 is attached to the frame 12 and includes a front differential 24 connected by a rotatable drive shaft 26 to an engine 28. By “engine” it is meant a machine that converts energy into mechanical motion. The drive train 22 further includes a transmission 30 directly secured to the engine 28 and having a drive shaft 32 extending outward from an opposite end thereof. By “transmission” it is meant an assembly of gears and associated parts by which power is transmitted from the engine 28 to the drive shaft 32. The opposite end of the drive shaft 32 is secured to a rear differential 34. By “differential” it is meant an arrangement of gears in an epicycle train permitting the rotation of two shafts at different speeds, used on vehicles to allow different rates of wheel rotation on curves. The rear differential 34 is also referred to as a powered drive that is capable of transmitting rotational motion to at least one rotatable shaft that extends outward therefrom.

It should be understood that the above described drive train 22 is only one example and all of the above-identified components do not have to be present in each drive train assembly.

Still referring to FIGS. 2 and 3, the front differential 24 has a pair of axles 36 extending horizontally outward therefrom in opposite directions. The pair of axles 36 can be independently or simultaneously rotated by the front differential 24 in a given direction, either clockwise or counter clockwise, and at a predetermined speed. It is possible to drive the front wheels 20 in a first direction, stop the rotation, and then drive the front wheels 20 in an opposite or second direction. Alternatively, the front wheels 20 do not have to be driven by the pair of axles 36 but instead can be designed to simply rotate on each of the pair of axles 36. Another option is to drive only one of the front wheels 20 and allow the other front wheel 20 to rotate freely. Normally, the pair of axles 36 are coaxially aligned and each terminates at a hub 38 onto which the front wheels 20 are mounted. The front wheels 20 are secured to the hubs 38 such that they are free to rotate. The specific construction needed to mount the front wheels 20 onto the hubs 38 is well known to those skilled in the art.

In FIG. 2, a pair of rear wheels 40 is also shown. Although the term “wheels” is used to explain this invention, it should be readily understood that either the front wheels 20 and/or the rear wheels 40 can be replaced by some other movable member. For example, a set of continuous tracks, similar to those used on certain bulldozers or tanks could be substituted for at least one pair of wheels. Other movable members known to those skilled in the art can also be used.

Referring now to FIG. 4, the pair of rear wheels 40 is secured to the drive train 22 by a drive mechanism 42. The drive mechanism 42 will be explained relative to the rear differential 34, but it should be understood that the drive mechanism 42 could also be utilized with the front differential 24, if desired. The drive mechanism 42 includes the rear differential 34 which is powered by the engine 28 via the drive train 22. The rear differential 34 has at least one shaft 44 extending outward therefrom. Desirably, the rear differential 34 has a pair of shafts 44 extending outward therefrom. More desirably, the pair of shafts 44 is coaxially aligned relative to one another and they extend horizontally outward from the rear differential 34 in opposite directions along the transverse axis Y-Y. Optionally, the pair of shafts 44 is not coaxially aligned. Furthermore, the pair of shafts 44 could extend outward from the rear differential 34 at an angle to the transverse centerline Y-Y. Desirably, the angle is from between about 0 degrees to about 45 degrees relative to the transverse axis Y-Y. Each of the pair of shafts 44 is capable of rotating in a given direction and at a predetermined speed. Alternatively, one or both of the pair of shafts 44 do not have to be driven.

A first gear 46 is mounted to an end of the shaft 44. Desirably, a first gear 46 is mounted to an end of each of the pair of shafts 44. By “mounted” it is meant a permanent attachment such as by welding, casting, forming, bolting, etc. The first gear 46 can be a bevel gear. By “bevel gear” it is meant a gear with teeth surfaces cut at an angle so that two associated gear shafts do not have to be aligned parallel to one another. The diameter of the first gear 46, the number of teeth on the first gear 46, the thickness of the first gear 46, the material from which the first gear 46 is formed, etc. can all be modified to suit one's particular needs and requirements. Normally, the first gear 46 is formed from a strong material, such as a metal or a metal alloy, to provide it with longevity. Other kinds of gears known to those skilled in the art can also be utilized, if desired.

At least one drive shaft 48, and desirably, a pair of drive shafts 48, each having a first end 50 and a second end 52, is also present in the drive mechanism 42. A gear 54 is mounted to the first end 50 and a gear 56 is mounted to the second end 52 of each of the drive shafts 48. The gears 54 can also be bevel gears oriented so that they are aligned parallel to the first gears 46. Each of the first gears 46 rotatably mesh with one of the gears 54. This interaction between each of the first gears 46 and one of the gears 54 provide a pair of pivot points 58. By “pivot” it is meant a member such as a short shaft or rod about which a related part rotates or swings.

It should be understood that one could practice this invention using a single shaft 44, a single first gear 46, a single drive shaft 48, etc. However, the invention is being explained with reference to a motorized vehicle 10 having a pair of rear wheels 40 and therefore a pair of shafts 44, a pair of first gears 46, a pair of drive shafts 48, etc. is needed.

The drive mechanism 42 also includes at least one hub 60 having a second gear 62 mounted thereto. Desirably, a pair of hubs 60 is present. Each hub 60 is rotatable and each hub 60 is capable of supporting a rotatable member, such as the rear wheels 40. Each of the pair of hubs 60 has a second gear 62 mounted thereto by a rotatable support shaft 64. The second gear 62 is also shown as a bevel gear. Each of the second gears 62 rotatably mesh with one of the gears 56 mounted to the second end 52 of each of the pair of drive shafts 48. This interaction between each of the second gears 62 and one of the gears 56 mounted to the second ends of the drive shafts 48 provide rotational motion but does not provide a pair of pivot points. In other words, the angle and alignment between the pair of hubs 60 and the drive shafts 48 does not vary. In FIG. 3, one will notice that the rear wheel 40 can move forward and backward, as indicated by the arcuate, arrowed line 66. Each of the rear wheels 40 can move forward or backward relative to the longitudinal axis X-X.

Returning again to FIG. 4, the drive mechanism 42 further includes at least one hollow support arm 68. Desirably, a pair of hollow support arms 68 is present. Each of the hollow support arms 68 can be formed from various materials, including but not limited to: cast iron, aluminum, steel, stainless steel, metal, a metal alloy, titanium, magnesium, etc. Each of the hollow support arms 68 is an elongated member that can vary in cross sectional shape. Desirably, each of the hollow support arms 68 has a circular or round cross-sectional shape. More desirably, each of the hollow support arms 68 has a diameter of at least about 1.5 inches. More desirably, each of the hollow support arms 68 has a diameter of at least about 2 inches. Even more desirably, each of the hollow support arms 68 has a diameter of at least about 3 inches.

Each of the hollow support arms 68 extends at least between one of the pair of pivot points 58 and one of the pair of hubs 60. Each of the pair of hollow support arms 68 has a horizontal vector Vₓ and a vertical vector V_{z}. The vertical vector V_{z} can be greater than, be equal to or be less than the horizontal vector Vₓ. Desirably, the vertical vector V_{z} is equal to or greater than the horizontal vector Vₓ. More desirably, the vertical vector V_{z} is greater than the horizontal vector Vₓ.

Each of the pair of hollow support arms 68 encloses one of the pair of drive shafts 48. Desirably, each of the pair of hollow support arms 68 completely encloses one of the pair of drive shafts 48. Each of the pair of hollow support arms 68 is an elongated member having a length I and each of the pair of drive shafts 48 has an overall length l₁. The length l of each of the support arms 68 is longer than the length l₁ of each of the pair of drive shafts 48. The exact cross-sectional shape of each of the pair of hollow support arms 68 can vary. The cross-sectional shape of each of the pair of hollow support arms 68 can be constant or change over the length l thereof. The cross-sectional shape of each of the pair of hollow support arms 68 can be round, circular, oval, triangular, square, rectangular, elliptical, pentagonal, hexagonal, octagonal, etc. These and any other geometrical shape or profile can be used for each of the pair of support arms 68.

Since each of the pair of drive shafts 48 can be machined to a predetermined outside diameter, the internal dimensions of each of the pair of hollow support arms 68 should be larger than the outside diameter of each of the drive shafts 48. This difference in size will permit each of the drive shafts 48 to freely rotate within each of the pair of hollow support arms 68. The specific amount of clearance located between the pair of rotatable drive shafts 48 and the interior walls of each of the pair of hollow support arms 68 can vary depending upon the design of a particular motorized vehicle 10. Desirably, there will be at least about 0.5 inches of clearance between a rotatable drive shaft 48 and the interior wall of the respective hollow support arm 68. More desirably, there will be at least about 1 inch of clearance between a rotatable drive shaft 48 and the interior wall of the respective hollow support arm 68. Even more desirably, there will be at least about 1.5 inches of clearance between a rotatable drive shaft 48 and the interior wall of the respective hollow support arm 68.

It should be noted that one or more bearings, bushings, etc. can be used to align the drive shafts 48 within the pair of hollow support arms 68 so as to allow each drive shaft 48 to rotate freely. The types, size, number of bearings, such as ball bearings, and bushings and their placement within the drive mechanism 42 can vary and are well within the knowledge of those skilled in the art.

Each of the pair of hollow support arms 68 is aligned at an angle alpha (6) relative to the vertical axis Z-Z. This angle \acute{α} will not change once the motorized vehicle 10 is constructed. The angle \acute{α} can be set at any desired number of degrees. Desirably, the angle \acute{α} will range from between about 1 degree to about 89 degrees. More desirably, the angle \acute{α} will range from between about 5 degrees to about 45 degrees. Even more desirably, the angle \acute{α} will range from between about 10 degrees to about 35 degrees. Most desirably, the angle \acute{α} will range from between about 15 degrees to about 30 degrees.

Returning again to FIGS. 2 and 4, each of the pair of hollow support arms 68 can be positioned so as to abut against a side or surface of the rear differential 34 or be spaced apart from the differential 34. In FIGS. 2 and 4, the pair of hollow support arms 68 is shown being spaced apart from the sides of the rear differential 34 by a pair of sleeves 70. Each of the pair of sleeves 70 can be a hollow cylindrical member used to space the pair of hollow support arms 68 away from the rear differential 34.

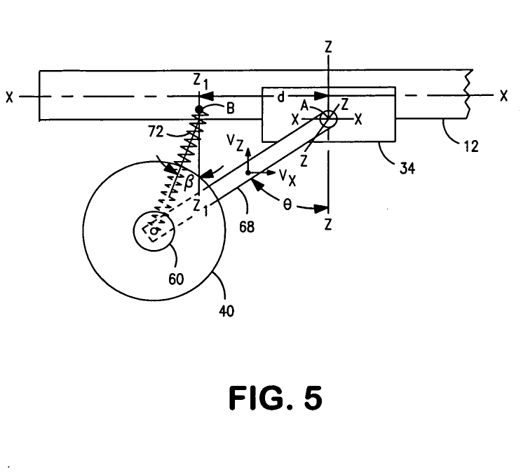

Referring now to FIG. 5, each of the pair of hollow support arms 68 is angled downward and rearward from the rear differential 34 at an angle theta (θ). The angle θ is measured between one of the pair of hollow support arms 68 and the vertical axis Z-Z. The angle θ can range from between about 1 degree to about 89 degrees. Desirably, the angle θ can range from between about 5 degrees to about 45 degrees. More desirably, the angle θ can range from between about 10 degrees to about 30 degrees. Even more desirably, the angle θ can range from between about 25 degree to about 40 degrees. The angle θ is capable of varying as the motorized vehicle 10 is driven over uneven terrain.

It should be understood that if the drive mechanism 42 is utilized on the front wheels 20, one could construct the support arms 68 so that they extend downward and rearward from the front differential 24. Optionally, one may wish to construct the support arms 68 so that they extend downward and forward from the front differential 24.

It should also be understood that the drive mechanism 42 can be replaced by a timing chain or by a drive belt, if desired. If a timing chain or belt drive is utilized, associated parts including one or more sprockets, gears, etc. will also be needed. These associated parts are well known to those skilled in the art.

Referring to FIGS. 2 and 5, the motorized vehicle 10 further includes at least one suspension mechanism 72 associated with each of the rear wheels 40 for cushioning the ride of the motorized vehicle 10. Desirably, a pair of suspension mechanisms 72 is present for the pair of rear wheels 40. A suspension mechanism 72 can also be utilized on each of the front wheels 20 as well. The suspension mechanisms 72, 72 can be in the form of one or more springs, coil springs, hydraulic cylinders, pneumatic cylinders, a combination of any of the aforementioned items, or any other shock absorbing mechanism known to those skilled in the art. In FIGS. 2 and 5, the suspension mechanism 72 is depicted as a coil spring. Each of the suspension mechanisms 72 is design to absorb vibrations and smooth out and cushion the ride of the motorized vehicle 10. Each of the suspension mechanisms 72 can be affixed between the frame 12 and one of the hubs 60 and/or 38. The size, shape, strength, length, etc. of each of the suspension mechanisms 72, 72 can be tailored to suit each particular motorized vehicle 10. The weight, length and width of the motorized vehicle 10, the weight of the driver, the passenger and the equipment the motorized vehicle 10 is designed to carry, the size of the wheels 20 and 40, etc. should be factored in when designing the suspension mechanisms 72. These factors are known to those skilled in the art.

Still referring to FIG. 5, each of the suspension mechanisms 72, 72 can be aligned perpendicular to the frame 12 or be aligned at an acute angle beta (β) thereto, as depicted. The angle β is measured between each of the suspension mechanisms 72, 72 and the vertical axis Z₁-Z₁ which passes through the point where the suspension mechanism 72 is attached to the frame 12. The angle β can range from about 0 degrees to about 30 degrees from a vertical axis Z₁-Z₁. Desirably, the angle β can range from about 1 degree to about 25 degrees from a vertical axis Z₁-Z₁. More desirably, the angle β can range from about 5 degrees to about 20 degrees from a vertical axis Z₁-Z₁. Even more desirably, the angle β can range from about 7 degrees to about 15 degrees from a vertical axis Z₁-Z₁.

The suspension mechanism 72 is also shown being connected to the frame 12 at a point B situated rearward of a point A where a respective support arm 68 is connected to the frame 12. The distance d between the two points A and B can vary. The distance d can range from between about 6 inches to about 24 inches. Desirably, the distance d ranges from between about 8 inches to about 20 inches. More desirably, the distance d ranges from between about 10 inches to about 18 inches. Even more desirably, the distance d ranges from between about 12 inches to about 15 inches. By positioning each of the suspension mechanisms 72, 72 behind or to the rear of the point A where the respective support arm 68 is connected to the frame 12, the suspension mechanisms 72, 72 will be able to function at keeping the rear wheels 40 in contact with the ground. This factor is important in providing a cushioned ride.

While the invention has been described in conjunction with a specific embodiment, it is to be understood that many alternatives, modifications and variations will be apparent to those skilled in the art in light of the aforegoing description. Accordingly, this invention is intended to embrace all such alternatives, modifications and variations which fall within the spirit and scope of the appended claims.

I claim:

1. A drive mechanism for a motorized vehicle comprising:
a) a differential having at least one rotatable shaft extending outward therefrom with a first gear mounted thereon;
b) a drive shaft having a first end and a second end with a gear mounted to each of said first and second ends, said first gear rotatably meshing with said gear mounted to said first end of said drive shaft and providing a pivot point for said drive shaft;
c) a rotatable hub capable of supporting a rotatable member, said hub having a second gear mounted thereto, said second gear rotatably meshing with said gear mounted to said second end of said drive shaft; and
d) a hollow support arm extending at least between said pivot point and said rotatable hub, said hollow support arm having a vertical vector and a horizontal vector, and said hollow support arm enclosing said drive shaft therein.

2. The drive mechanism for a motorized vehicle of claim 1 wherein said motorized vehicle contains an engine which powers a drive train and said drive train is connected to said differential, and said hollow support arm is spaced apart from said differential.

3. The drive mechanism for a motorized vehicle of claim 2 wherein said hollow support arm has a horizontal vector and a vertical vector, said vertical vector is greater than said horizontal vector, and said hollow support arm is angled downward and rearward from said differential.

4. The drive mechanism for a motorized vehicle of claim 3 wherein said hollow support arm is an elongated member having a diameter of at least about 1.5 inches and a length greater than said drive shaft.

5. The drive mechanism for a motorized vehicle of claim 4 wherein said drive shaft has a predetermined outside diameter and said hollow support arm has an internal dimension at least about 0.5 inches larger than said outside diameter of said drive shaft to permit said drive shaft to freely rotate therein.

6. The drive mechanism for a motorized vehicle of claim 5 wherein said hollow support arm extends downward and rearward from said differential at an angle ranging from between about 1 degree to about 89 degrees measured relative to a vertical axis.

7. The drive mechanism for a motorized vehicle of claim 1 wherein said hollow support arm extends downward and rearward from said differential at an angle ranging from between about 5 degrees to about 45 degrees measured relative to a vertical axis, and said outside diameter of said drive shaft is spaced at least about 1 inch from said internal dimension of said hollow support arm.

8. The drive mechanism for a motorized vehicle of claim 1 wherein said powered drive is a differential and said hollow support arm extends downward and rearward from said differential at an angle ranging from between about 10 degrees to about 30 degrees measured relative to a vertical axis, and said outside diameter of said drive shaft is spaced at least about 2 inches from said internal dimension of said hollow support arm.

9. The drive mechanism for a motorized vehicle of claim 1 wherein said vehicle has a frame, and a suspension mechanism which includes a coil spring is secured between said frame and each of said rotatable hubs to cushion the ride of said vehicle.

10. A drive mechanism for a motorized vehicle comprising:
a) a differential connected to said frame, said differential having a pair of coaxially aligned shafts extending outward therefrom in opposite directions, each of said pair of shafts capable of rotating in a given direction and at a predetermined speed;
b) a first gear mounted to an end of each of said pair of shafts;
c) a pair of drive shafts each having a first end and a second end with a gear mounted to each of said first and second ends, each of said first gears meshing with one of said gears mounted to said first ends of said drive shafts and providing a pair of pivot points;
d) a pair of hubs each capable of supporting a rotatable member, each of said hubs having a second gear mounted thereto, each of said second gears meshing with one of said gears mounted to said second end of said pair of drive shafts; and
e) a pair of hollow support arms each extending between one of said pair of pivot points and one of said pair of hubs, each of said pair of hollow support arms having a vertical vector and a horizontal vector, and each of said pair of hollow support arms enclosing one of said pair of drive shafts.

11. The drive mechanism for a motorized vehicle of claim 10 wherein each of said pair of hollow support arms is angled downward and rearward from said differential and said vertical vector of each of said hollow support arms is greater than said horizontal vector.

12. The drive mechanism for a motorized vehicle of claim 11 wherein each of said pair of hollow support arms extend downward and rearward from said differential at an angle ranging from between about 5 degrees to about 45 degrees measured relative to a vertical axis.

13. The drive mechanism for a motorized vehicle of claim 12 wherein each of said pair of hollow support arms is an elongated member having a diameter of at least about 1.5 inches and a length greater than said respective drive shaft, and wherein each of said pair of hollow support arms is spaced apart from said differential.

14. The drive mechanism for a motorized vehicle of claim 13 wherein each of said drive shafts has a predetermined outside diameter and each of said pair of hollow support arms has an internal dimension at least about 0.5 inches larger than said outside diameter of said respective drive shaft to permit said respective drive shaft to freely rotate therein.

15. The drive mechanism for a motorized vehicle of claim 14 wherein said vehicle has a frame and a pair of suspension mechanisms connected between said frame and each of said hubs, each of said pair of suspension mechanisms including a coil spring, said coil springs capable of cushioning the ride of said vehicle.

16. A drive mechanism for a motorized vehicle having a frame, comprising:
a) a differential secured to said frame, said differential having a pair of coaxially aligned shafts extending horizontally outward therefrom in opposite directions, each of said pair of shafts capable of rotating in a given direction and at a predetermined speed;
b) a first bevel gear mounted to an end of each of said pair of shafts;
c) a pair of drive shafts each having a first end and a second end with a bevel gear mounted to each of said first and second ends, each of said first bevel gears rotatably meshing with one of said bevel gears mounted to said first ends of said drive shafts, and said bevel gears providing a pair of pivot points;
d) a pair of hubs each capable of supporting a rotatable member, each of said hubs having a second bevel gear mounted thereto, each of said second bevel gears rotatably meshing with one of said bevel gears mounted to said second end of said pair of drive shafts;
e) a pair of hollow support arms each extending between one of said pair of pivot points and one of said pair of hubs, each of said pair of hollow support arms having a vertical vector and a horizontal vector, and each of said pair of hollow support arms enclosing one of said pair of drive shafts; and
f) a suspension mechanism affixed between said frame and each of said pair of hubs to cushion the ride of said motorized vehicle.

17. The drive mechanism for a motorized vehicle of claim 16 wherein each of said pair of hollow support arms is angled downward and rearward from said differential and said vertical vector is greater than said horizontal vector.

18. The drive mechanism for a motorized vehicle of claim 17 wherein each of said pair of hollow support arms extend downward and rearward from said differential at an angle ranging from between about 1 degree to about 89 degrees measured relative to a vertical axis.

19. The drive mechanism for a motorized vehicle of claim 18 wherein each of said pair of hollow support arms is an elongated member having a length longer than said respective drive shaft, and each of said pair of hollow support arms is spaced apart from said differential.

20. The drive mechanism for a motorized vehicle of claim 19 wherein each of said drive shafts has a predetermined outside diameter and each of said pair of hollow support arms has an internal dimension that is at least about 0.5 inches larger than said outside diameter of said respective drive shaft to permit said respective drive shaft to freely rotate therein.
